(19) United States
(12) Patent Application Publication
(10) Pub. No.: US 2007/0277327 A1
(43) Pub. Date: Dec. 6, 2007

(54) Detergent And Cleaning Agents Containing Dye Fixatives And Soil Release Polymers

(75) Inventors: Michael Wessling, Kandern (DE); Frank-Peter Lang, Hattersheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT PRODUKTE (DEUTSCHLAND) GMBH, Frankfurt am Main (DE)

(21) Appl. No.: 11/547,785

(22) PCT Filed: Apr. 6, 2005
(86) PCT No.: PCT/EP05/03602

§ 371 Date: Nov. 29, 2006

(30) Foreign Application Priority Data
Apr. 8, 2004 (DE) 10 2004 018 051.2

(51) Int. Cl. C11D 3/37; C11D 3/16

(52) U.S. Cl. 8/137

(57) ABSTRACT

The invention relates to detergents and cleaning agents that contain both a dye fixative and a soil-release polymer. According to the invention, the dye fixatives used are (a) reaction products of polyamines and cyanamides and organic and/or inorganic acids, or cyanamides and aldehydes and ammonium salts, or cyanamides and aldehydes and amines, or amines and epichlorohydrin, (b) the group containing polyamines and polyamine derivatives, (c) the group containing polyimines and polyimine derivatives, (d) the group of cationic polyelectrolytes, (e) the group containing polymers that comprise imidazoline units or (f) the group containing bis(chloromethyl)biphenyl polyquat.

The invention relates to washing and cleaning compositions which comprise a combination of one or more dye fixative(s) and one or more soil release polymer(s).

A known problem in the washing of colored textiles is that they fade over several wash cycles. This problem occurs in particular in the case of dark-colored textiles made of cotton and mixed cotton fabrics. In the case of effectively fixed textile dyes, this process takes place over a prolonged period of use.

When, in contrast, the fibers of a dyed textile are poorly fixed, i.e. the textile “bleeds”, not just rapid fading of the colored textile takes place, but there can also, as a result of the relatively high dye concentrations in the wash liquor, additionally be staining of differently colored or white textiles washed at the same time. In any case, though, colored textiles lose their mint appearance relatively rapidly, as a result of which the useful life of the textile is restricted.

To solve the problem of bleeding or of fading of colored textiles, the literature proposes the use of so-called dye fixatives. WO 98/29529 claims washing compositions which comprise at least one anionic surfactant, an organic or inorganic builder and a dye fixative. The dye fixatives used must not react with the anionic surfactant. WO 96/27649 claims washing composition formulations which comprise a combination of a cationic dye fixative and of a cellulose. WO 01/44423 describes the claim for laundry care formulations which comprise a dye fixative, an N-heterocyclic polymer and a nonionic surfactant.

The N-heterocyclic polymers listed are compounds which are known as dye transfer inhibitors, for example polyvinylpyrrolidone. EP 1 239 025 and EP 1 236 793 describe washing compositions and laundry treatment compositions which comprise dye transfer-inhibiting dye fixatives. However, a problem with all dye fixatives is that they increase the redeposition of detached, particulate soil from the washing liquor onto the textile and hence promote the graying of the laundry. This problem is particularly marked in the case of the cationic dye fixatives. However, it can occur with all dye fixatives.

Also known is the use of so-called soil release polymers in washing and cleaning compositions for textiles for improving the soil detachment from synthetic fibers, especially from polyester and polyester blend fabrics. These soil release polymers are water-soluble or water-dispersible polycondensates based on dicarboxylic acids and diols, or are cellulose ethers.

The purpose of the present invention is to provide washing and cleaning composition formulations which comprise one or more dye fixatives and which, compared to the corresponding reference formulations without dye fixatives, do not bring about increased soil redeposition.

It has now been found that, surprisingly, this aim can be achieved by the combination of the dye fixative(s) with one or more soil release polymers.

The invention provides

washing and cleaning compositions comprising
a) reaction products of polyamines with cyanamides and organic and/or inorganic acids or cyanamides with aldehydes and ammonium salts or cyanamides with aldehydes and amines or amines with epichlorohydrin,
b) the group of the polyamines and polyamine derivatives,
c) the group of polyimines and polyimine derivatives,
d) the group of the cationic polyelectrolytes,
e) the group of the polymers containing imidazoline units or
f) the group of the bischloromethylbiphenyl polyquats and a soil release polymer.

The dye fixatives which can be used in the combinations with soil release polymers described are anionic, nonionic or cationic and are described below:

Polycondensates which can be used as dye fixatives are obtained by reacting polyamines with cyanamides and organic or inorganic acids, by the reaction of cyanamides with aldehydes and ammonium salts and/or amines, or by the reaction of amines with epichlorohydrin.

The dye fixatives used may also be polyamines or derivatives thereof.

Such polyamines may have the general structure
H₂N—R¹—(NH—R²)ₙ—NH₂

where R1 and R2 are each linear or branched C₁-C₄-alkylene, for example ethylene, propylene, butylene, and n is an integer from 0 to 1000. Examples of polyamines are diethylenetriamine (DETA), triethylene-tetramine (TETA), tetraethylenepentamine (TEPA), pentaethylenehexamine (PEHA), dipropylenetriamine. The polyamines may also be branched via tertiary nitrogen atoms. Polyamine derivatives are in particular amine alkoxylates, for example amine ethoxylates, amine oxides, betaines and quaternary ammonium salts. The polyamine derivatives are obtained by full or partial reaction of the polyamines with alkylene oxides, especially ethylene oxide, with hydrogen peroxide, with halocarboxylic acids, for example chloroacetic acid or chloropropionic acid, and/or with alkylating agents, for example methyl chloride, dimethyl sulfate or benzyl chloride. Polymers which can also be used as dye fixatives are polyethyleneimines. These are obtainable, for example, from BASF under the tradename Lupasol.

The dye fixatives used may also be cationic polyelectrolytes. These are, for example, homo- and copolymers based on diallyidimethylammonium chloride (DADMAC).

Copolymers based on DADMAC contain, as further components, other vinylic monomers, for example vinylimidazole, vinylpyrrolidone, vinyl alcohol, vinyl acetate (meth)acrylic acid/esters and acrylamide. Such polymers are, for example, obtainable under the tradenames Agefloc, Agequat and Tinofix, for example Agefloc WT 40, Agefloc WT 40 SV, Agefloc WT 40 SVL and Tinofix FRD (from Ciba SC).

Homopolymers based on DADMAC are obtainable under the tradenames Dodigen 3954, Dodigen 4033 and Genamin PDAC (from Clariant). Further polymers based on vinylic monomers may contain acrylamidomethylpropanesulfonic acid (AMPS).

Useful dye fixatives are also basic polycondensates having imidazoline units as described in WO 01/74982.

It is also possible to use bichloromethylbiphenyl polyquats, as described in DE 2 657 582 and EP 225 281.

Further dye fixatives are, for example: Levogen and Lavafix brands (Bayer), Gafquat brands (ISP), Nebfix brands (Nicca), the Sevofix brands (Textil Color) and the Tinofix brands, for example Tinofix CL, Tinofix ULC, Tinofix ECO, Cibafix ECO and Solfix E (Ciba SC). Particularly preferred dye fixatives are the TexCare DFC brands (Clariant).

Soil release polymers which can be used together with dye fixatives are, for example, cellulose ethers or polycondensates based on dibasic carboxylic acids and reactants which possess two or more hydroxyl groups. The dibasic carboxylic acid used is typically terephthalic acid. These soil release polymers may be nonionic or anionic.

Nonionic soil release polymers and their use in washing and cleaning compositions are, for example, described in U.S. Pat. No. 4,116,885, EP 185 427, EP 442 101, DE 4 403 866, DE 195 22 431 and EP 964 015.

The following structural formulae illustrate, by way of example, the chemical structure of nonionic soil release polymers:

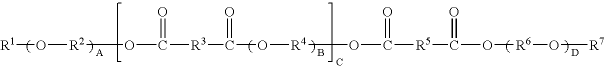

FIG. 1: Soil release polymer I

Soil release polymer I:
R¹ and R⁷ linear or branched C₁-C₁₈-alkyl
R², R⁴, R⁶ alkylene, e.g. ethylene, propylene, butylene
R³ and R⁵ 1,4-phenylene, 1,3-phenylene
A, B and D a number from 1 to 200
C a numberfrom 1 to 20

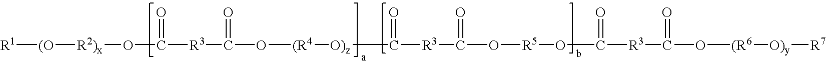

FIG. 2: Soil release polymer II

Soil release polymer II:
R¹ and R⁷ linear or branched C₁-C₁₈-alkyl,
R² and R⁶ ethylene,
R³ 1,4-phenylene,
R⁴ ethylene
R⁵ ethylene, 1,2-propylene or random mixtures of any composition of the two,
x and y each independently a number from 1 to 500,
z a number from 10 to 140,
a a numberfrom 1 to 12,
b a number from 7 to 40,
where a+b is at least equal to 11.

More preferably, each independently,
R¹ and R⁷ are each linear or branched C₁-C₄-alkyl,
x and y are each a number from 3 to 45,
z is a number from 18 to 70,
a is a number from 2 to 5,
b is a number from 8 to 12,
a+b is a number from 12 to 18 or from 25 to 35.

Anionic soil release polymers are, for example, described in U.S. Pat. No. 4,721,580, WO 95/02028, WO 95/02029, EP 707 627, U.S. Pat. Nos. 5,691,298, 5,700,386, 5,843,878 and WO 96/18715.

The anionic monomers used to prepare the oligo- or polyesters are, in addition to the aforementioned monomers, for example, hydroxyethanesulfonic acid (isethionic acid), hydroxypropanesulfonic acid, their reaction products with ethylene oxide, glyceryl sulfoethyl ether and sulfoisophthalitic acid.

Among these esters, preference is given to those which have the following features:

polyesters having a molar mass of less than 20 000, preferably of less than 10 000 and most preferably of less than 5 000; polyesters which are end-capped by means of alkyl polyalkylene glycols; polyesters which are end-capped by means of methyl polyethylene glycols, where the number of ethylene glycol units is </=90, preferably <=50 and more preferably </=20; polyesters which have preferably </=60% by mass and more preferably </=50% by mass of esterified terephthalic acid units; polyesters which contain ethylene glycol or polyethylene glycol units; polyesters which contain propylene glycol or propylene glycol units; polyesters which contain both ethylene glycol or polyethylene glycol and propylene glycol or polypropylene glycol units; polyesters which are anionically modified by means of copolymerized sulfoisophthalic units.

Additionally useful as soil release polymers are also cellulose ethers, preferably those having a molar mass of less than 150 000. Examples thereof are methylcellulose, methylhydroxycellulose and methylhydroxypropylcellulose.

Commercial soil release polymers are supplied under the trade names Repel-O-Tex, for example Repel-O-Tex SRP 4, Repel-O-Tex SRP 6, Repel-O-Tex PF, Repel-O-Tex PF 594 (from Rhodia), Sokalan, for example Sokalan SR 100 (from BASF), Marloquest, for example Marloquest SL (from Sasol) and TexCare, for example TexCare SRN-170, TexCare SRN-240 and TexCare SRN-325 (from Clariant).

The inventive active substance combination is preferably used in a use concentration of from 0.1 to 20% by weight, preferably from 0.1 to 10% by weight and more preferably from 0.1 to 5% by weight, most preferably from 0.3 to 3% by weight, based on the washing and cleaning compositions.

The preferred weight ratio of dye fixative to soil release polymer is from 1:10 to 10:1, preferably from 1:5 to 5:1.

The washing composition formulations in which the inventive combinations of dye fixative(s) and soil release polymer(s) can be used are present in the form of powders, granules, pellets, tablets, bars or blocks, pastes, gels or liquids.

These forms may be packaged into films which either have a protective function in the course of storage or else serve as a metering aid. The films may be water-soluble.

Dye fixative(s) and soil release polymer(s) can also be applied in a procedure in which one of the two components is present separately from the washing composition formulation and is metered separately to the wash cycle.

However, it is also possible for the combination of a dye fixative and of a soil release polymer to be provided separately from the actual washing composition formulation and to be added to the wash cycle as required.

The inventive combination of a dye fixative and of a soil release polymer can also be used in laundry pretreatment and aftertreatment compositions or in wash boosters. Laundry aftertreatment compositions are laundry conditioners, for example laundry fabric softeners.

Washing and cleaning compositions which comprise the inventive active substance formulation may additionally comprise further constituents. These are described below.

Anionic Surfactants

Useful anionic surfactants include sulfates, sulfonates, carboxylates, phosphates and mixtures thereof. Suitable cations here are alkali metals, for example sodium or potassium, or alkaline earth metals, for example calcium or magnesium, and also ammonium, substituted ammonium compounds, including mono-, di- or triethanolammonium cations and mixtures thereof.

The following types of anionic surfactants are particularly preferred: alkyl ester sulfonates, alkyl sulfates, alkyl ether sulfates, alkylbenzenesulfonates, alkanesulfonates and soaps, as described below.

Alkyl ester sulfonates include linear esters of C₈-C₂₀-carboxylic acids (e.g. fatty acids) which are sulfonated by means of gaseous SO₃, as described, for example, in “The Journal of the American Oil Chemists Society” 52 (1975), p. 323-329.

Suitable starting materials are natural fats, such as tallow, coconut oil and palm oil, but may also be of synthetic nature.

Preferred alkyl ester sulfonates, especially for washing composition applications, are compounds of the formula 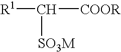
in which R¹ is a C₈-C₂₀-hydrocarbyl radical, preferably alkyl, and R is a C₁-C₆-hydrocarbyl radical, preferably alkyl. M is a cation which forms a water-soluble salt with the alkyl ester sulfonate. Suitable cations are sodium, potassium, lithium or ammonium cations, for example monoethanolamine, diethanolamine and triethanolamine. Preferably, R¹ is C₁₀-C₁₆-alkyl and R is methyl, ethyl or isopropyl. Most preferred are methyl ester sulfonates in which R¹ is C₁₀-C₁₆-alkyl.

Alkyl sulfates here are water-soluble salts or acids of the formula ROSO₃M in which R is a C₁₀-C₂₄-hydrocarbyl radical, preferably an alkyl or hydroxyalkyl radical with C₁₀-C₂₀-alkyl component, more preferably a C₁₂-C₁₈-alkyl or hydroxyalkyl radical.

M is hydrogen or a cation, for example an alkali metal cation (for example sodium, potassium, lithium), or ammonium or substituted ammonium cation, for example methyl-, dimethyl- and trimethylammonium cations, or quaternary ammonium cations such as tetramethylammonium and dimethylpiperidinium cations, and quaternary ammonium cations derived from alkylamines such as ethylamine, diethylamine, triethylamine and mixtures thereof.

Alkyl chains with C₁₂-C₁₆ are preferred for low washing temperatures (e.g. below about 50° C.) and alkyl chains with C₁₆-C₁₈ are preferred for higher washing temperatures (e.g. above about 50° C.).

Alkyl ether sulfates are water-soluble salts or acids of the formula RO(A)ₘ SO₃M in which R is an unsubstituted C₁₀-C₂₄-alkyl or hydroxyalkyl radical, preferably a C₁₂-C₂₀-alkyl or hydroxyalkyl radical, more preferably a C₁₂-C₁₈-alkyl or hydroxyalkyl radical.

A is an ethoxy or propoxy unit, m is a number greater than 0, preferably from approx. 0.5 to approx. 6, more preferably from approx. 0.5 to approx. 3, and M is a hydrogen atom or a cation, for example sodium, potassium, lithium, calcium, magnesium, ammonium or a substituted ammonium cation. Specific examples of substituted ammonium cations comprise methyl-, dimethyl-, trimethylammonium and quaternary ammonium cations, such as tetramethylammonium and dimethylpiperidinium cations, and also those which are derived from alkylamines such as ethylamine, diethylamine, triethylamine or mixtures thereof. Examples include C₁₂-C₁₈ fatty alcohol ether sulfates in which the content of ethylene oxide units is 1, 2, 2.5, 3 or 4 mol per mole of the fatty alcohol ether sulfate and M is sodium or potassium.

In secondary alkanesulfonates, the alkyl group may either be saturated or unsaturated, branched or linear, and may optionally be substituted by a hydroxyl group.

The sulfo group may be at any position in the carbon chain, but the primary methyl groups at the start of the chain and at the end of the chain do not have any sulfonate groups.

The preferred secondary alkanesulfonates comprise linear alkyl chains having from approx. 9 to 25 carbon atoms, preferably from approx. 10 to approx. 20 carbon atoms and more preferably from approx. 13 to 17 carbon atoms. The cation is, for example, sodium, potassium, ammonium, mono-, di- or triethanolammonium, calcium or magnesium and mixtures thereof. Sodium is the preferred cation.

In addition to secondary alkanesulfonates, it is also possible to use primary alkanesulfonates in the inventive washing compositions.

The preferred alkyl chains and cations correspond to those of the secondary alkanesulfonates.

The preparation of primary alkanesulfonic acids, from which the corresponding sulfonates effective as surfactants are obtained, is described, for example, in EP 854 136 A1.

Further suitable anionic surfactants are alkenyl- or alkylbenzenesulfonates. The alkenyl or alkyl group may be branched or linear and may optionally be substituted by a hydroxyl group. The preferred alkylbenzenesulfonates comprise linear alkyl chains having from approx. 9 to 25 carbon atoms, preferably from approx. 10 to approx. 13 carbon atoms; the cation is sodium, potassium, ammonium, mono-, di- or triethanolammonium, calcium or magnesium and mixtures thereof.

For mild surfactant systems, magnesium is the preferred cation, while sodium is preferred for standard washing applications. The same applies to alkenylbenzenesulfonates.

The term anionic surfactants also includes olefinsulfonates which are obtained by sulfonation of C₁₂-C₂₄-α-olefins, preferably C₁₄-C₁₆-α-olefins, with sulfur trioxide and subsequent neutralization. As a result of the preparation process, these olefinsulfonates may comprise relatively small amounts of hydroxyalkanesulfonates and alkanedisulfonates. Specific mixtures of α-olefinsulfonates are described in U.S. Pat. No. 3,332,880.

Further preferred anionic surfactants are carboxylates, for example fatty acid soaps and comparable surfactants. The soaps may be saturated or unsaturated and may comprise various substituents, such as hydroxyl groups or a-sulfonate groups. Preference is given to linear saturated or unsaturated hydrocarbyl radicals as the hydrophobic moiety having from approx. 6 to approx. 30, preferably from approx. 10 to approx. 18, carbon atoms.

Further useful anionic surfactants include salts of acylaminocarboxylic acids; the acyl sarcosinates which are formed by reacting fatty acid chlorides with sodium sarcosinate in an alkaline medium; fatty acid/protein condensation products which are obtained by reacting fatty acid chlorides with oligopeptides; salts of alkylsulfamidocarboxylic acids; salts of alkyl ether carboxylic acids and alkylaryl ether carboxylic acids; sulfonated polycarboxylic acids which are prepared by sulfonation of the pyrolysis products of alkaline earth metal citrates, as described, for example, in GB-1,082,179; alkyl glyceryl sulfates and alkenyl glyceryl sulfates, such as oleyl glyceryl sulfates; alkylphenol ether sulfates; alkyl phosphates; alkyl ether phosphates; isethionates, such as acyl isethionates; N-acyltaurides; alkyl succinates; sulfosuccinates; monoesters of sulfosuccinates (particularly saturated and unsaturated C₁₂-C₁₈ monoesters) and diesters of sulfosuccinates (particularly saturated and unsaturated C₁₂-C₁₈ diesters); acyl sarcosinates; sulfates of alkylpolysaccharides, such as sulfates of alkylpolyglycosides, branched primary alkyl sulfates and alkylpolyethoxycarboxylates, such as those of the formula RO(CH₂CH₂)ₖCH₂COO⁻M⁺ in which R is C₈- to C₂₂-alkyl, k is a number from 0 to 10 and M is a cation.

Further examples are described in “Surface Active Agents and Detergents” (Vol. I and II, Schwartz, Perry and Berch).

Nonionic Surfactants

Condensation products of aliphatic alcohols with from approx. 1 to approx. 25 mol of ethylene oxide.

The alkyl chain of the aliphatic alcohols may be linear or branched, primary or secondary, and contains generally from approx. 8 to approx. 22 carbon atoms. Particular preference is given to the condensation products of C₁₀-C₂₀-alcohols with from approx. 2 to approx. 18 mol of ethylene oxide per mole of alcohol. The alkyl chain may be saturated or else unsaturated. The alcohol ethoxylates may have a narrow homolog distribution (“narrow range ethoxylates”) or a broad homolog distribution of the ethylene oxide (“broad range ethoxylates”).

Examples of commercially available nonionic surfactants of this type are Tergitol® 5-S-9 (condensation product of a linear secondary C₁₁-C₁₅-alcohol with 9 mol of ethylene oxide), Tergitol® 24-L-NMW (condensation product of a linear primary C₁₂-C₁₄-alcohol with 6 mol of ethylene oxide with narrow molar mass distribution). This product class likewise includes the Genapol® brands of Clariant GmbH.

Condensation products of ethylene oxide with a hydrophobic base, formed by condensation of propylene oxide with propylene glycol.

The hydrophobic moiety of these compounds preferably has a molecular weight from approx. 1500 to approx. 1800. The addition of ethylene oxide onto this hydrophobic moiety leads to an improvement in the water solubility. The product is liquid up to a polyoxyethylene content of approx. 50% of the total weight of the condensation product, which corresponds to a condensation with up to approx. 40 mol of ethylene oxide. Commercially available examples of this product class are, for example, the Pluronic® brands of BASF and the ®Genapol brands of Clariant GmbH.

Condensation products of ethylene oxide with a reaction product of propylene oxide and ethylenediamine.

The hydrophobic unit of these compounds consists of the reaction product of ethylenediamine with excess propylene oxide and generally has a molecular weight of from approx. 2500 to 3000. Ethylene oxide is added onto this hydrophobic unit until the product has a content of from approx. 40 to approx. 80% by weight of polyoxyethylene and a molecular weight of from approx. 5000 to 11 000. Commercially available examples of this compound class are, for example, the Tetronic® brands from BASF and the ®Genapol PN brands of Clariant GmbH.

Semipolar Nonionic Surfactants

This category of nonionic compounds comprises water-soluble amine oxides, water-soluble phosphine oxides and water-soluble sulfoxides, each having an alkyl radical of from approx. 10 to approx. 18 carbon atoms. Semipolar nonionic surfactants are also amine oxides of the formula 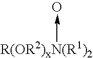
where R is an alkyl, hydroxyalkyl or alkylphenol group with a chain length of from approx. 8 to approx. 22 carbon atoms. R² is an alkylene or hydroxyalkylene group having from approx. 2 to 3 carbon atoms or mixtures thereof, each radical R¹ is an alkyl or hydroxyalkyl group having from approx. 1 to approx. 3 carbon atoms or a polyethylene oxide group having about 1 to about 3 ethylene oxide units, and x is a number from 0 to about 10. The R¹ groups may be joined together via an oxygen or nitrogen atom and thus form a ring. Amine oxides of this type are particularly C₁₀-C₁₈-alkyldimethylamine oxides and C₈-C₁₂-alkoxyethyldihydroxy-ethylamine oxides.
Fatty Acid Amides

Fatty acid amides have the formula 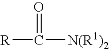
in which R is an alkyl group having from approx. 7 to approx. 21, preferably from approx. 9 to approx. 17, carbon atoms, and R¹ is in each case independently hydrogen, C₁-C₄-alkyl, C₁-C₄-hydroxyalkyl or (C₂H₄O)ₓH where x varies from about 1 to about 3. Preference is given to C₈-C₂₀ amides, monoethanolamides, diethanolamides and isopropanolamides.

Further suitable nonionic surfactants are alkyl- and alkenyloligoglycosides, and also fatty acid polyglycol esters or fatty amine polyglycol esters each having from 8 to 20, preferably from 12 to 18, carbon atoms in the fatty alkyl radical, alkoxylated triglycamides, mixed ethers or mixed formyls, alkyloligoglycosides, alkenyloligoglycosides, fatty acid N-alkylglucamides, phosphine oxides, dialkyl sulfoxides and protein hydrolyzates.

Polyethylene oxide, polypropylene oxide and polybutylene oxide condensates of alkylphenols.

These compounds include the condensation products of alkylphenols having a C₆-C₂₀-alkyl group, which may be linear or branched, with alkene oxides. Preference is given to compounds having from approx. 5 to 25 mol of alkene oxide per mole of alkylphenol. Commercially available surfactants of this type are, for example, lgepal® CO-630, Triton® X45, X-114, X-100 and X102, and the ®Arkopal-N brands of Clariant GmbH. These surfactants are referred to as alkylphenol alkoxylates, for example alkylphenol ethoxylates.

Zwitterionic Surfactants

Typical examples of amphoteric or zwitterionic surfactants are alkylbetaines, alkylamidobetaines, aminopropionates, aminoglycinates or amphoteric imidazolinium compounds of the formula 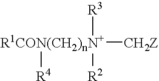
in which R¹ is C₈-C₂₂-alkyl or -alkenyl, R² is hydrogen or CH₂CO₂M, R³ is CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation such as an alkali metal, alkaline earth metal, ammonium or alkanolammonium cation.

Preferred amphoteric surfactants of this formula are monocarboxylates and dicarboxylates. Examples thereof are cocoamphocarboxypropionate, cocoamidocarboxypropionic acid, cocoamphocarboxyglycinate (also referred to as cocoamphodiacetate) and cocoamphoacetate.

Further preferred amphoteric surfactants are alkyldimethylbetaines (®Genagen LAB/Clariant GmbH) and alkyldipolyethoxybetaines with an alkyl radical having from approx. 8 to approx. 22 carbon atoms which may be linear or branched, preferably having from 8 to 18 carbon atoms and more preferably having from approx. 12 to approx. 18 carbon atoms.

Suitable cationic surfactants are substituted or unsubstituted, straight-chain or branched, quaternary ammonium salts of the R¹N(CH₃)₃⁺X⁻, R¹R²N(CH₃)₂⁺X⁻, R¹R²R³N(CH₃)⁺X⁻ or R¹R²R³R⁴N⁺X⁻ type. The R¹, R², R³ and R⁴ radicals are each independently preferably unsubstituted alkyl having a chain length of from 8 to 24 carbon atoms, in particular from 10 to 18 carbon atoms, hydroxyalkyl having from approx. 1 to approx. 4 carbon atoms, phenyl, C₂-C₁₈-alkenyl, C₇-C₂₄-aralkyl, (C₂H₄O)ₓH where x is an integer from 1 to 3, alkyl radicals comprising one or more ester groups, or cyclic quaternary ammonium salts. X is a suitable anion.

Further washing composition ingredients which may be present in the present invention include inorganic and/or organic builders in order to reduce the hardness of the water.

These builders may be present in the washing and cleaning compositions in proportions by weight of from about 5% to about 80%.

Inorganic builders include, for example, alkali metal, ammonium and alkanolammonium salts of polyphosphates, for instance tripolyphosphates, pyrophosphates and glasslike polymeric metaphosphates, phosphonates, silicates, carbonates including bicarbonates and sesquicarbonates, sulfates and aluminosilicates.

Examples of silicate builders are the alkali metal silicates, especially those having an SiO₂:Na₂O ratio between 1.6:1 and 3.2:1, and also sheet silicates, for example sodium sheet silicates, as described in U.S. Pat. No. 4,664,839, obtainable from Clariant GmbH under the SKS® brand. SKS-6® is a particularly preferred sheet silicate builder.

Aluminosilicate builders are particularly preferred for the present invention. They are particularly zeolites having the formula Na_{z}[(AlO₂)_{z}(SiO₂)_{y}].xH₂O where z and y are integers of at least 6, the ratio of z to y is from 1.0 to about 0.5, and x is an integer from about 15 to about 264.

Suitable ion exchangers based on aluminosilicate are commercially available. These aluminosilicates may be of crystalline or amorphous structure, and may be naturally occurring or else synthetically produced. The processes for the production of ion exchangers based on aluminosilicate are described in U.S. Pat. Nos. 3,985,669 and U.S. Pat. No. 4,605,509. Preferred ion exchangers based on synthetic crystalline aluminosilicates are obtainable under the name Zeolite A, Zeolite P(B) (including those disclosed in EP-A-0 384 070) and Zeolite X. Preference is given to aluminosilicates having a particle diameter between 0.1 and 10 μm.

Suitable organic builders (cobuilders) include polycarboxyl compounds, for example ether polycarboxylates and oxydisuccinates, as described, for example, in U.S. Pat. Nos. 3,128,287 and 3,635,830. Reference should likewise be made to “TMS/TDS” builders from U.S. Pat. No. 4,663,071.

Other suitable builders include the ether hydroxypolycarboxylates, copolymers of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids, for example ethylenediaminetetraacetic acid and nitrilotriacetic acid, and also polycarboxylic acids such as mellitic acid, succinic acid, oxydisuccinic acid, polymaleic acid, benzene-1,3,5-tricarboxylic acid, carboxymethyloxysuccinic acid, and soluble salts thereof.

Important organic builders are also polycarboxylates based on acrylic acid and maleic acid, for example the Sokalan CP brands of BASF.

Builders based on citrate, for example citric acid and its soluble salts, especially the sodium salt, are preferred polycarboxlic acid builders, which may also be used in granulated formulations, especially together with zeolites and/or sheet silicates.

Further suitable builders are the 3,3-dicarboxy-4-oxa-1,6-hexanedioates and the related compounds which are disclosed in U.S. Pat. No. 4,566,984.

When builders based on phosphorus are used, and especially when bars of soap for handwashing are to be formulated, various alkali metal phosphates, for instance sodium tripolyphosphate, sodium pyrophosphate and sodium orthophosphate, may be used. It is likewise possible to use phosphonate builders such as ethane-1-hydroxy-1,1-diphosphonate and other known phosphonates, as disclosed, for example, in U.S. Pat. Nos. 3,159,581, 3,213,030, 3,422,021, 3,400,148 and 3,422,137.

The washing and cleaning compositions which comprise the inventive combination of a dye fixative and of a soil release polymer may also comprise the customary assistants which enhance the cleaning action, serve for the care of the textile to be washed or alter the use properties of the washing composition.

Suitable assistants include the substances mentioned in U.S. Pat. No. 3,936,537, for example enzymes, especially proteases, lipases, cellulases and amylases, mannanases, enzyme stabilizers, foam enhancers, foam inhibitors, tarnish and/or corrosion inhibitors, suspension media, dyes, dye transfer inhibitors, fillers, optical brighteners, disinfectants, alkalis, hydrotropic compounds, antioxidants, perfumes, solvents, solubilizers, redeposition inhibitors, dispersants, processing assistants, softeners and antistats.

The washing compositions of the present invention may optionally comprise one or more conventional bleaches, and also bleach activators, bleach catalysts and suitable stabilizers. In general, it must be ensured that the bleaches used are compatible with the cleaning composition ingredients. Conventional test methods, for instance the determination of the bleaching activity of the ready-formulated cleaning composition as a function of the storage time, may be used for this purpose.

Peroxy acids may be used either as the free peroxy acid, or it is possible to use a combination of an inorganic per salt, for example sodium perborate or sodium percarbonate, and an organic peroxy acid precursor.

The organic peroxy acid precursors are often referred to in the prior art as bleach activators.

Examples of suitable organic peroxy acids are disclosed in U.S. Pat. Nos. 4,374,035, 4,681,592, 4,634,551, 4,686,063, 4,606,838 and U.S. Pat. No. 4,671,891.

The examples of compositions which are suitable for bleaching laundry and which comprise perborate bleaches and activators are described in U.S. Pat. Nos. 4,412,934, 4,536,314, 4,681,695 and 4,539,130.

Examples of peroxy acids which are preferred for use in this invention include peroxydodecanedioic acid (DPDA), the nonyl amide of peroxysuccinic acid (NAPSA), the nonyl amide of peroxyadipic acid (NAPAA) and decyldiperoxysuccinic acid (DDPSA), nonanoylamido-caproyloxybenzenesulfonic acid and alkanoyloxybenzenesulfonic acids such as nonanoyloxybenzenesulfonic acid (NOBS) and lauryloxybenzene-sulfonic acid (LOBS).

In the inventive washing compositions and laundry treatment compositions, particular preference is given to using bleach systems based on a per salt such as perborates or percarbonates with the bleach activator tetraacetylethylenediamine (TAED).

### EXAMPLES

The following liquid laundry detergent formulations A, B and C were prepared (see table 1).

The formulation A serves as the reference. The formulation B additionally comprises a dye fixative, and the formulation C comprises the inventive combination of a dye fixative with a soil release polymer.

TABLE 1
Composition of liquid laundry detergents in % by weight

| Constituents | Formulation A | Formulation B | Formulation C |
|---|---|---|---|
| Soap | 6% | 6% | 6% |
| Alkyl ether sulfate | 0.6% | 0.6% | 0.6% |
| Alkyl etheroxylate | 12% | 12% | 12% |
| TexCare DFC 6 | — | 0.4 | 0.4 |
| TexCare SRN-170 | — | 0 | 1.5 |
| Water | ad 100 | ad 100 | ad 100 |

The soil redeposition was examined on wfk 10 A cotton fabric, wfk 20 A mixed cotton/polyester fabric and wfk 30 A polyester fabric in a Miele domestic washing machine.

Structure of the Commercial Products Used:

TexCare DFC 6: Polyamine derivative. Dye fixative for washing compositions/from Clariant
TexCare SRN-170: Nonionic soil release polyester/from Clariant

For this purpose, the test fabric with the laundry detergent formulations was subjected to repeated washing with addition of standardized wfk 09V pigment soil (see table 2).

TABLE 2
Wash conditions

| | |
|---|---|
| Washing composition dosage | 100 ml |
| Amount of wash liquor | 12 ltr |
| Water hardness | 15° GH |
| Wash temperature | 60° C. |
| Wash program | Easy care |

The measure used for the soil redeposition was the whiteness of the test fabric at the start, and after five, 10 and 15 wash cycles. The higher the whiteness, the lower the soil redeposition.

TABLE 3
Whiteness of wfk 10 A cotton after repeated washing

Wash cycles

| | 0 | 5 | 10 | 15 |
|---|---|---|---|---|
| Formulation A | 78.3 | 77.5 | 76.3 | 73.6 |
| Formulation B | 78.3 | 76.3 | 72.8 | 66.9 |
| Formulation C | 78.3 | 77.7 | 76.6 | 74.3 |

TABLE 4
Whiteness of wfk 20 A cotton/polyester after repeated
washing

Wash cycles

| | 0 | 5 | 10 | 15 |
|---|---|---|---|---|
| Formulation A | 85.0 | 82.5 | 82.1 | 80.4 |
| Formulation B | 85.5 | 81.4 | 78.7 | 74.4 |
| Formulation C | 85.5 | 81.9 | 80.2 | 78.7 |

TABLE 5
Whiteness of wfk 30 A polyester after repeated washing

Wash cycles

| | 0 | 5 | 10 | 15 |
|---|---|---|---|---|
| Formulation A | 78.3 | 77.0 | 76.5 | 75.3 |
| Formulation B | 78.2 | 78.0 | 76.7 | 74.5 |
| Formulation C | 78.2 | 78.2 | 78.0 | 77.8 |

1. A washing and cleaning composition comprising a dye fixative selected from
a) reaction products of polyamines with cyanamides and organic and/or inorganic acids or cyanamides with aldehydes and ammonium salts or cyanamides with aldehydes and amines or amines with epichlorohyddn,
b) the group of the polyamines and polyamine derivatives,
c) the group of polyimines and polyimine derivatives,
d) the group of the cationic polyelectrolytes,
e) the group of the polymers containing imidazoline units or
f) the group of the bischloromethylbiphenyl polyquats and a soil release polymer.

2. The washing and cleaning composition as claimed in claim 1, wherein the soil release polymer is a water-soluble or water-dispersible polyester.

3. The washing and cleaning composition as claimed in claim 1, wherein the soil release polymer is a water-soluble or water-dispersible polyester having a molar mass of less than 20 000.

4. The washing and cleaning composition as claimed in claim 1, wherein the soil release polymer is a water-soluble or water-dispersible polyester which is end-capped by alkyl polyalkylene glycols.

5. The washing and cleaning composition as claimed in claim 1, wherein the soil release polymer is a water-soluble or water-dispersible polyester which is end-capped by methyl polyethylene glycols, the number of ethylene glycol units being less than or equal to 90.

6. The washing and cleaning composition as claimed in claim 1, wherein the soil release polymer is a the water-soluble or water-dispersible polyester which has less than or equal to 60% by mass of esterified terephthalic acid units.

7. The washing and cleaning composition as claimed in claim 1, wherein the soil release polymer is a water-soluble or water-dispersible polyester which contains ethylene glycol or polyethylene glycol units.

8. The washing and cleaning composition as claimed in claim 1, wherein the soil release polymer is a water-soluble or water-dispersible polyester which contains propylene glycol or polypropylene glycol units.

9. The washing and cleaning composition as claimed in claim 1, wherein the soil release polymer is a water-soluble or water-dispersible polyester which contains both ethylene glycol or polyethylene glycol and propylene glycol or polypropylene glycol units.

10. The washing and cleaning composition as claimed in claim 1, wherein the soil release polymer is a water-soluble or water-dispersible polyester which has been modified anionically by means of copolymerized sulfoisophthalic acid or glycerol sulfoethyl ether units and mixtures thereof.

11. The washing and cleaning composition as claimed in claim 1, wherein the soil release polymer is a water-soluble or water-dispersible polyester which is end-capped by means of isethionic acid, hydroxypropanesulfonic acid or their reaction products with ethylene oxide.

12. The washing and cleaning composition as claimed in claim 1, wherein the soil release polymer is a cellulose ether.

13. The washing and cleaning composition as claimed in claim 1, wherein the soil release polymer is a methylhydroxyethylcellulose.

14. The washing and cleaning composition as claimed in claim 1, wherein the soil release polymer is a methylhydroxypropylcellulose.

15. The washing and cleaning composition as claimed in claim 1, wherein the soil release polymer is a methylcellulose.

16. The washing and cleaning composition as claimed in claim 1, wherein the soil release polymer is a cellulose ether having a molar mass of less than 150 000.

17. The washing and cleaning composition as claimed in claim 1, wherein the ratio of dye fixative to soil release polymer is from 1:10 to 10:1.

18. The washing and cleaning composition as claimed in claim 1, wherein the use concentration of the combination of dye fixative and soil release polymer in the washing composition is from 0.1 to 20% by weight.

19. The washing and cleaning composition as claimed in claim 1, wherein the ratio of dye fixative to soil release polymer is from 1:5 to 5:1.

20. The washing and cleaning composition as claimed in claim 1, wherein the use concentration of the combination of dye fixative and soil release polymer in the washing composition is from 0.1 to 10% by weight.

21. The washing and cleaning composition as claimed in claim 1, wherein the use concentration of the combination of dye fixative and soil release polymer in the washing composition is from 0.1 to 5% by weight.

22. The washing and cleaning composition as claimed in claim 1, wherein the use concentration of the combination of dye fixative and soil release polymer in the washing composition is from 0.3 to 3% by weight.

23. The washing and cleaning composition as claimed in claim 1, wherein the soil release polymer is a water-soluble or water-dispersible polyester which is end-capped by methyl polyethylene glycols, the number of ethylene glycol units being less than or equal to 50.

24. The washing and cleaning composition as claimed in claim 1, wherein the soil release polymer is a water-soluble or water-dispersible polyester which is end-capped by methyl polyethylene glycols, the number of ethylene glycol units being less than or equal to 20.

25. The washing and cleaning composition as claimed in claim 1, wherein the soil release polymer is a water-soluble or water-dispersible polyester having a molar mass of less than 10 000.

26. The washing and cleaning composition as claimed in claim 1, wherein the soil release polymer is a water-soluble or water-dispersible polyester having a molar mass of less than 5 000.

27. The washing and cleaning composition as claimed in claim 1, wherein the soil release polymer is a the water-soluble or water-dispersible polyester which has less than or equal to 50% by mass of esterified terephthalic acid units.
